(19) United States
(12) Patent Application Publication
(10) Pub. No.: US 2008/0159472 A1
(43) Pub. Date: Jul. 3, 2008

(54) DEVICE FOR IMPROVING THE RESOLUTION CAPABILITY OF AN X-RAY OPTICAL APPARATUS

(75) Inventors: Albrecht Frey, Ofterdingen (DE); Norbert Pailer, Stetten (DE); Jess Koehler, Ottobrunn (DE)

Correspondence Address: GREENBLUM & BERNSTEIN, P.L.C., 1950 ROLAND CLARKE PLACE, RESTON, VA, 20191, US

(73) Assignee: ASTRIUM GmbH, Muenchen (DE)

(21) Appl. No.: 11/928,676

(22) Filed: Oct. 30, 2007

(30) Foreign Application Priority Data
Oct. 31, 2006 (DE) 102006051912.4-54

(51) Int. Cl. G21K 1/06

(52) U.S. Cl. 378/43

(57) ABSTRACT

The present invention describes a device for improving the resolution capability of an x-ray optical apparatus for an x-ray (24) incident from a direction of incidence, which device comprises a mirror element (52, 54) with a mirror edge (52), the mirror edge (52) being formed around an edge axis (58) by a cylindrical shell section, the mirror element (52, 54) being arranged spaced apart in a radial direction (42) with respect to a focal axis (25) parallel to the direction of incidence by a focal point of the x-ray optical apparatus, and the mirror element (52, 54) being furthermore arranged rotated about an axis extending in the radial direction (42) with respect to the direction of incidence such that the edge axis (58) is tilted with respect to the direction of incidence.

The invention relates to a device for improving the spatial resolution of a micropore optics system for x-rays pursuant to claim 1.

In the construction of a telescope for x-rays the problem arises that no suitable lenses exist for x-ray radiation because of the low refraction and the strong absorption in matter. Mirrors in the conventional sense cannot be used either, since the reflectivity for x-rays, unlike for visible light, is too low by far. Adequate reflectivity values result only for very large angles of incidence close to 90 degrees. This effect can be used to build a reflecting telescope for x-rays, provided that suitably designed surfaces are found. The x-rays must thereby strike the reflecting surface at a very small angle (grazing incidence), since x-rays are reflected by polished surfaces only when the incidence of the rays is almost grazing. One possibility for realizing an x-ray telescope is therefore to use a parabolic reflector. However, the parabolic reflector has very large image errors under the conditions of a grazing incidence.

A Wolter I-type telescope is known from the prior art (see, e.g., also the publication “Spiegelsysteme streifenden Einfalls als abbildende Optiken für Röntgenstrahlen,” H. Wolter, Analen der Physik, 10, 1952, p. 94-114). A telescope of this type utilizes the reflection of x-ray radiation with grazing incidence on metal surfaces. The basic concept is that a hyperboloid is placed behind the paraboloid as correcting reflector, on which hyperboloid the x-rays are reflected for a second time.

The mirror arrangement of the Wolter-I type is composed of metallic (often comprising only coated foils) paraboloids of revolution multiply nested within one another, each of which is followed by a hyperboloid of revolution. These mirrors together have similar imaging properties like conventional telescopes in the visible range of light. In that case the rays are first reflected on a small section of a parabolic reflector and subsequently on a section of a hyperbolic reflector. In order to achieve greater intensities, several mirror systems of this type were nested within one another, since, due to the grazing incidence, each pair of mirrors has only a very narrow range in which it can collect x-ray light and focus it in the focal point. For example, in the mirror system of the ROSAT x-ray satellite four Wolter double mirrors with the same focal length are nested within one another in order to obtain a large collecting area.

Furthermore, from the prior art an approximation of the Wolter-I optics is known, which uses several stacks of cylindrical areas with single tilt, which replaces the paraboloids and hyperboloids. This type of approximation can be tolerated if large focal lengths are chosen.

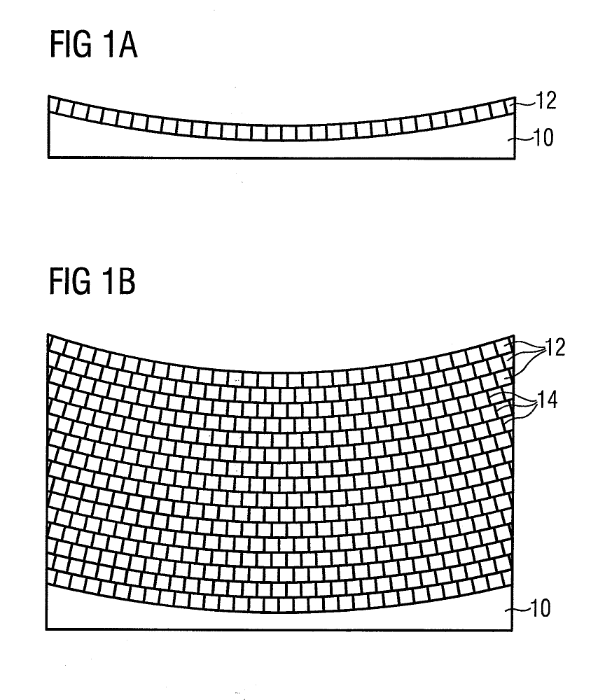

Furthermore, an x-ray lens has hitherto been produced by a pore optics system, the reflecting surfaces of which an ideal Wolter-I optics system approximates through two cylindrical areas. A pore optics system of this type is shown in FIGS. 1A and 1B. An approximation occurs for production-relevant reasons: The cylindrical mirror shells 12 are applied layer by layer on a cylindrical base 10, as shown in FIG. 1A (see FIG. 1B). A mirror shell is polished on the front face and provided on the back with many webs 14. The webs 14 of the mirror shell 12 last applied are connected to the mirror surface of the mirror shell 12 lying underneath, so that the last mirror surface again is curved exactly like the one underneath it. This production method requires the spaces remaining between the webs 14 and the mirror shells 12, the pores, to have a rectangular cross section.

The advantage of a pore optics system is to be able to produce many mirror shells precisely and to mount them one behind the other. The mirror shells are connected to one another by webs, which leads to the geometry of many small pores. However, one disadvantage of the prior art is that the spatial resolution of the x-ray optics of known solutions no longer meets current requirements.

An object of the present invention is therefore to create a device for an x-ray optics system that achieves an improved spatial resolution compared to the prior art.

This object is attained through a device according to claim 1.

Preferred embodiments of the invention are shown by the dependent claims.

The present invention creates a device for improving the resolution capability of an x-ray optical apparatus for an x-ray incident from a direction of incidence, comprising

a mirror element with a mirror edge, the first mirror edge being formed by a first cylindrical shell section around an edge axis, and the mirror element being arranged spaced apart with respect to a focal axis parallel to the direction of incidence by a focal point of the x-ray optical apparatus in a radial direction, and the mirror element being furthermore arranged rotated about an axis extending in the radial direction with respect to the direction of incidence such that the edge axis is tilted with respect to the direction of incidence.

The present invention is based on the realization that through a rotation of the mirror element about the radial axis an approximation of the parabolic and hyperbolic form can be achieved, which is oriented closer to the optimal form than is rendered possible by a simple approximation of cylindrical shells.

The device according to the invention has the advantage that it can lead to an improvement in the spatial resolution of an x-ray image, which can have a wide field of application with the a broad use of x-ray optical devices. In other words, one advantage of the device according to the invention is that it results in less blurring of the image, which in turn leads to a better image quality. The desired reduction of the image blurring can be dependent on the stack length and the focal length. The improvement in the resolution can be, e.g., in the range of a factor of 3.

According to one embodiment of the invention, a second mirror edge can be provided adjacent to the mirror edge, which second mirror edge is formed about a second edge axis by a second cylindrical shell section, where the mirror element can be arranged such that a plane comprising the edge axis and second edge axis is tilted with respect to the direction of incidence. This has the advantage that now not only can the transition between the first and second mirror edge be better approximated, but also in addition to the mirror edge the second mirror edge can be produced cost-effectively by cylinder approximation.

In order to produce a mirror element that corresponds particularly well to the Wolter-I optics, according to one embodiment of the invention the mirror edge can correspond to an approximation of a parabolic form and the second mirror edge to an approximation of a hyperbolic form.

In order for the mirror element to represent a particularly good approximation of the Wolter-I optics, according to another embodiment of the invention the mirror element can have a width that is smaller than approximately a tenth of the radial distance of the mirror element regarding the focal axis. This can ensure that the approximation range does not become too large, so that the approximation does not become inadmissible.

According to one embodiment of the invention, the mirror element can have a width that corresponds to an arc length of less than approximately two degrees in the radial direction. This range of the width of the mirror element provides a still better approximation of the form of the Wolter-I optics, since the range to be approximated is very small compared to the entire parabolic and hyperbolic form of the Wolter-I optics, so that the approximation does not cause any major errors.

According to one embodiment of the invention, an incline between the edge axis and the direction of incidence can be in a range between approximately half a degree and approximately five degrees, which is characterized as a particularly good inclination range for improving the resolution capability of the x-ray optical apparatus.

In order to achieve a further improvement of the resolution capability of the x-ray optical apparatus, according to one embodiment of the invention, another mirror element with a third mirror edge and a fourth mirror edge adjacent to the third mirror edge can be provided, the third mirror edge being formed by a third cylindrical shell section around a third edge axis and the other mirror element being arranged spaced apart with respect to the focal axis in another radial direction, and the other mirror element furthermore being arranged rotated about another axis extending in the other radial direction with respect to the direction of incidence, such that the third edge axis is tilted with respect to the direction of incidence. Through the provision of another mirror element of this type, an improvement of the yield of the incident x-rays can thus be achieved.

According to one embodiment of the invention, the other mirror element can be adjacent to the mirror element and be arranged at a distance from the focal axis that corresponds to the spacing of the mirror element from the focal axis, and a lateral transition between the mirror element and the other mirror element can have a stepped offset. Through this tilted arrangement of the mirror elements, the area of the vertical expansion of the border line between the first and second mirror edge or the third and fourth mirror edge can be kept in a very narrow range, so that incident x-rays on both mirror elements can be deflected to a very small focal area or focal point. If the arrangement of the mirror elements were chosen such that the border lines between the first and the second mirror edge and the third and the fourth mirror edge touched, an arrangement of this type would not cause an optimal focusing on a joint focal point.

According to one embodiment of the invention, it can be advantageous if the device according to the invention comprises a plurality of additional mirror elements that form a ring of mirror elements around the focal axis. This causes x-rays from a plurality of mirror elements to be deflected to a single focal range or focal point, which in turn increases the intensity of the light spot in the focal point. A better detection or evaluation capability of the incident x-rays is then hereby possible.

The device according to one embodiment of the invention can also have an additional mirror element, which is arranged spaced apart from the focal axis in the radial direction, a spacing of the additional mirror element from the focal axis being larger than the spacing of the mirror element from the focal axis. In particular, a device of this type is advantageous when the additional mirror element has two mirror edges that are tilted with respect to one another so that an x-ray incident in the direction of incidence is reflected to an essentially identical focal point, like an x-ray that is deflected on the mirror element. An improvement of the resolution behavior can thus likewise be achieved by a nested arrangement.

Further advantages and application possibilities of the present invention are shown by the following description in conjunction with the exemplary embodiments shown in the drawings.

The terms and associated reference numbers used in the list of reference numbers given at the end are used in the specification, in the claims, in the abstract and in the drawings.

The drawings show in:

FIGS. 1A and 1B Representations of the structure of a pore optics system;

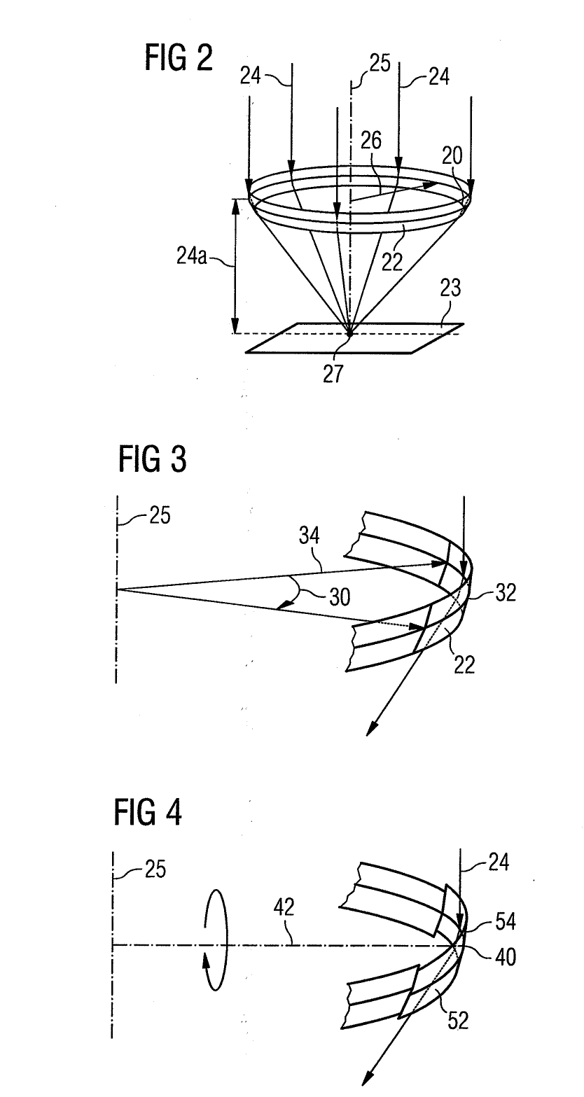

FIG. 2 A diagrammatic representation of two mirror shells one after the other according to the Wolter-I arrangement;

FIG. 3 A representation of cylinder segments of a mirror shell;

FIG. 4 A representation of an exemplary embodiment of the rotation of cylinder segments around the radial axis of the telescope arrangement;

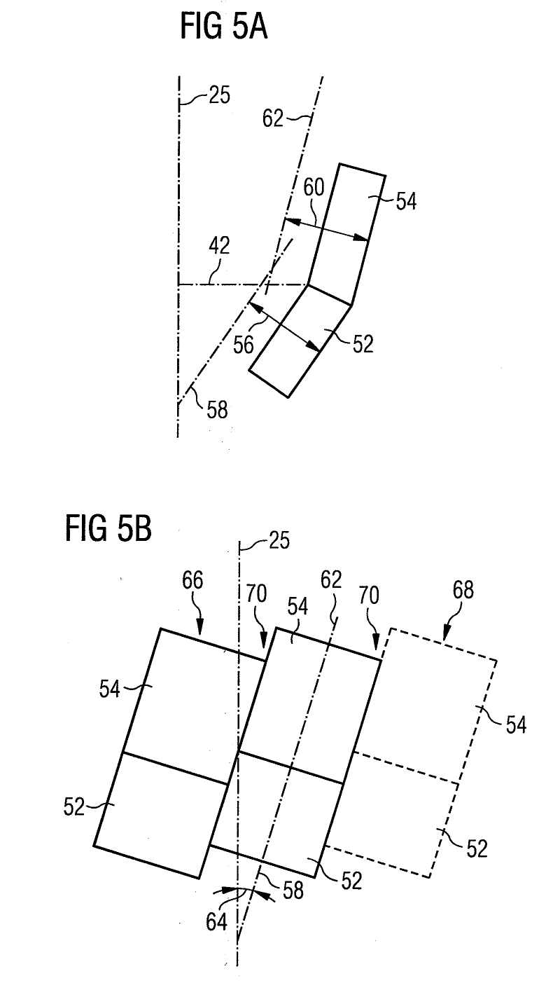

FIGS. 5A and 5B Representations of an exemplary embodiment of the present invention in two different sectional views;

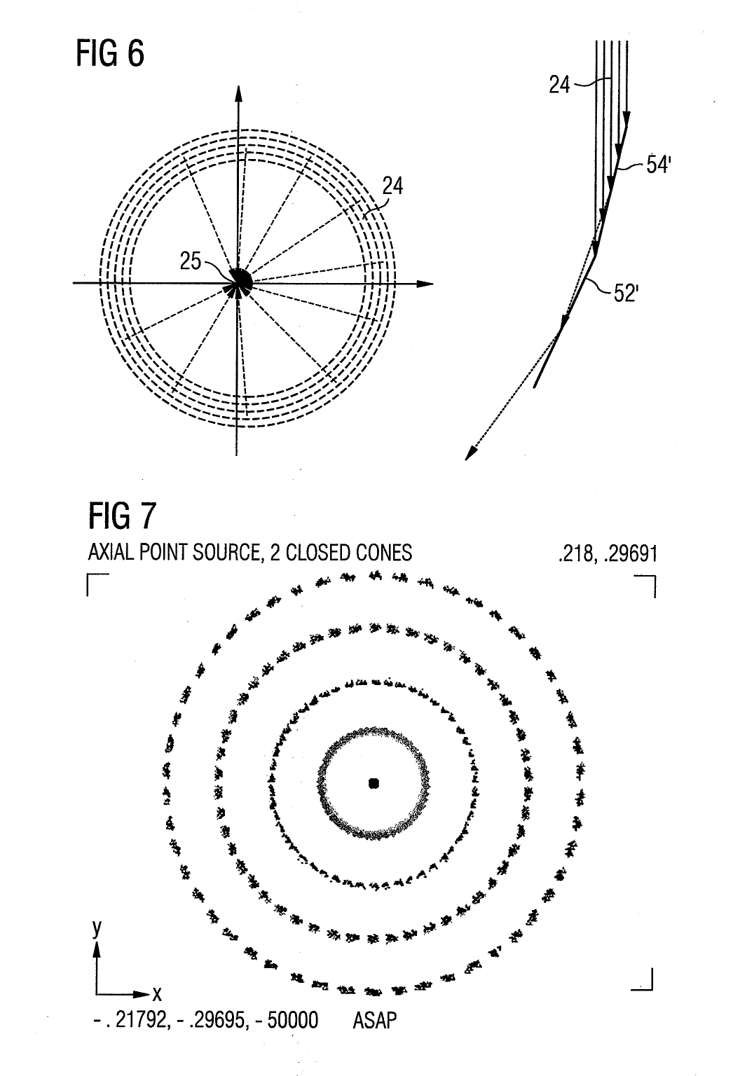

FIG. 6 A representation of the deflection of light rays at the telescope;

FIG. 7 A spot diagram in the focal plane, conical mirror shells being used to generate the spot diagram;

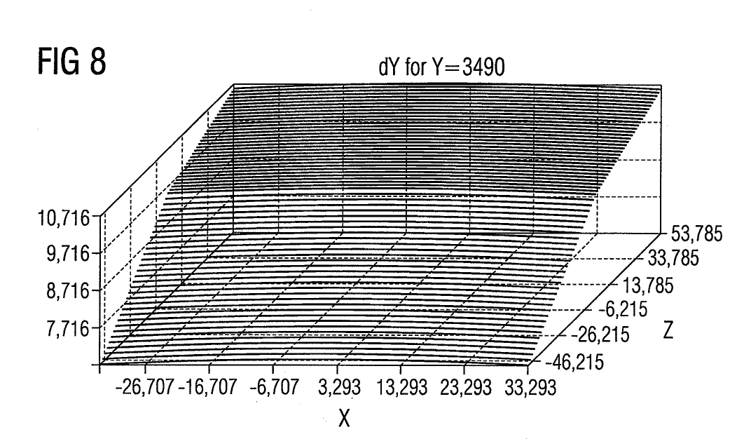

FIG. 8 A diagram of the deviation when using a mirror element of two cylinder surfaces;

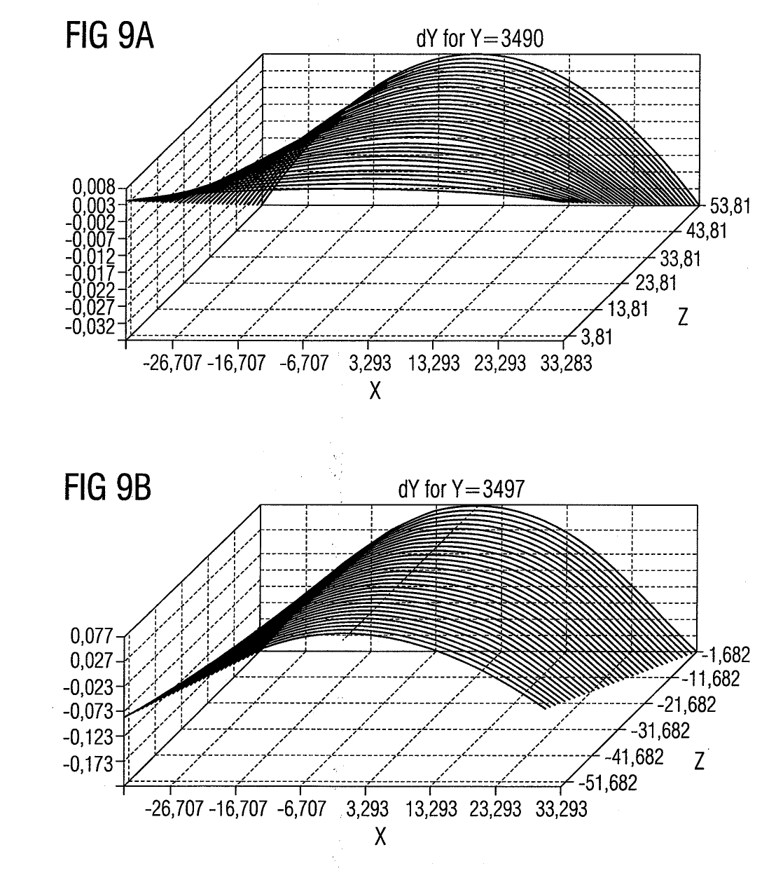

FIGS. 9A and 9B Diagrams of the deviation of the cylinder approximation of a conical surface for a paraboloid (FIG. 9A) or a hyperboloid (FIG. 9B);

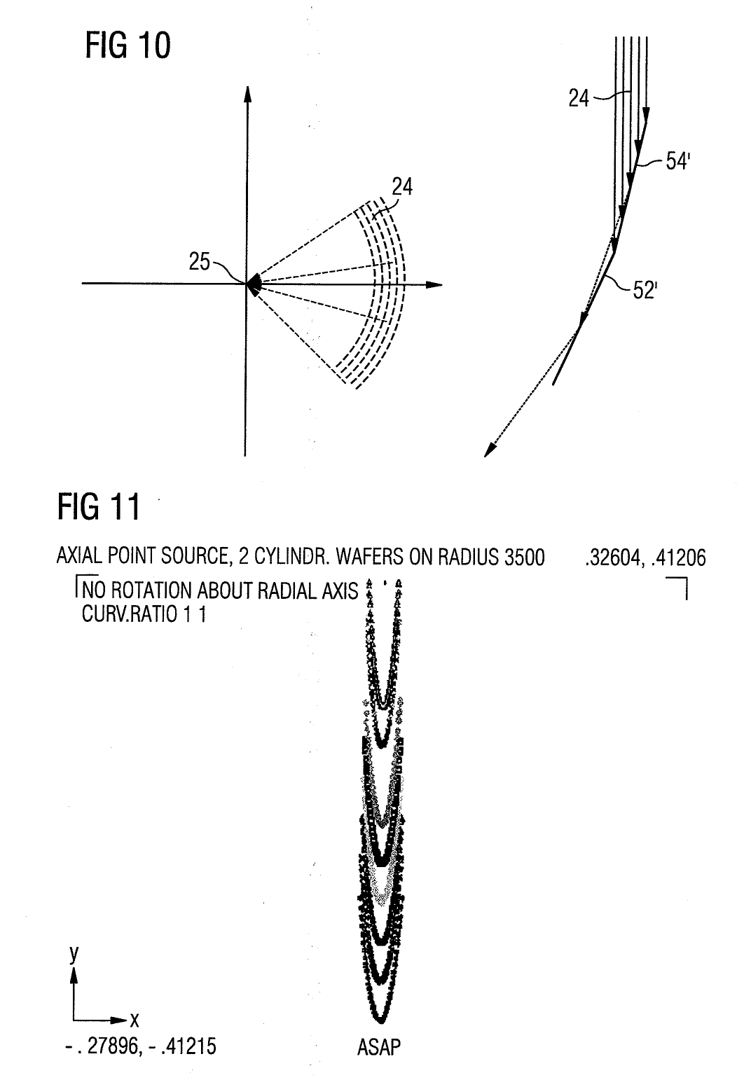

FIG. 10 A representation of the illumination of the mirror element of two cylindrical shells;

FIG. 11A spot diagram in the focal plane, which is generated by a mirror element with cylinder surfaces;

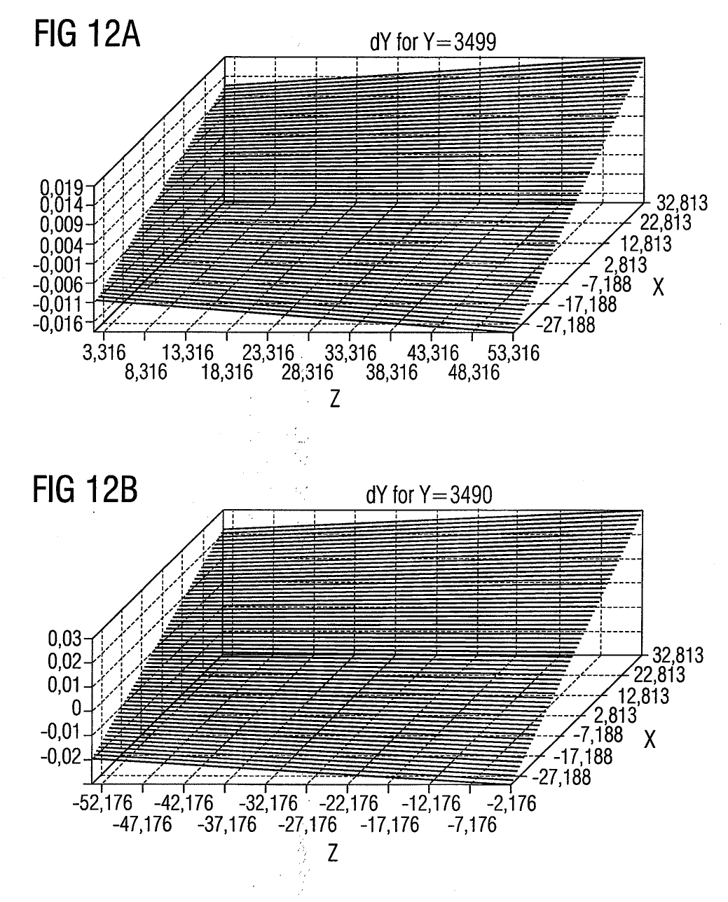

FIGS. 12A and 12B Diagrams of the deviation of an exemplary embodiment of the present invention from an unmodified cylinder approximation for the first mirror edge (FIG. 12A) and the second mirror edge (FIG. 12B); and

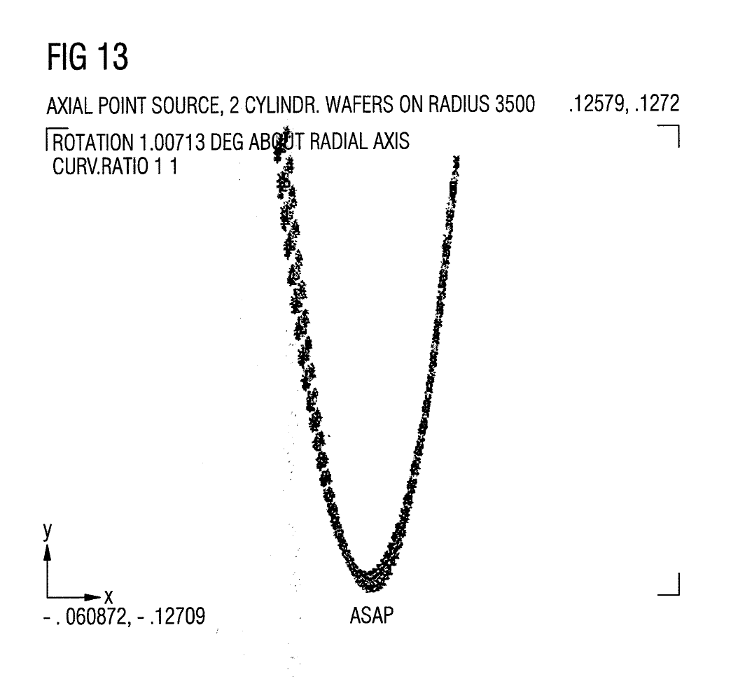

FIG. 13 A spot diagram in the focal plane that is obtained through a mirror element according to an exemplary embodiment of the present invention.

To explain the present invention more precisely, first the fundamental concepts will be explained in more detail which lead to the devices according to the invention. Absolute size data in the following description and the drawings are only exemplary data, which do not restrict the invention.

### 1. Conical Approximation to the Wolter-I Optics for X-Ray Astronomy

An x-ray telescope can comprise mirror shells 20, 22, which represent a so-called Wolter-I optics. Then the mirror shell 20 facing the object is a section of a paraboloid, and the mirror shell 22 facing the image plane is a section of a hyperboloid. Accordingly, the first mirror shell 20 would be the paraboloid section and the second mirror shell 22, the hyperboloid section, as shown in FIG. 2.

In order to always work in the range of the grazing incidence of x-rays 24, the sections of the paraboloid and of the hyperboloid are narrow mirror shells. They are usually arranged in a staggered manner, in order to image a greater quantity of light on the focal plane 23 at a distance 24a from the mirror shells 20, 22. It is customary to approximate the narrow shell-shaped sections of the paraboloid and of the hyperboloid through conical elements. In this case, the mirrors 20 and 22 represent ring-shaped sections of conical surfaces with a radius 26. The two cones forming the basis have a cone axis that is identical to the telescope symmetry axis (or focal axis 25). The included angles are selected such that the conical surfaces at the location of the mirror shells 20 and 22 fit against one another tangentially. In the exemplary embodiment, a conical approximation of a Wolter-I optics system is described by way of introduction.

One criterion for assessing the quality of the optical image is the diameter of the light spot 27 in the focal plane 23. A small spot 27 means that the resolution capability of the telescope is large, while with a large light spot 27 no distinction can be made between two objects lying close together. It is therefore the object of every optical telescope to generate the smallest possible light spot 27 in the focal plane 23.

### 2. Cylinder Approximation

A production of whole mirror shells 20, 22 is complex. It is expedient to undertake an azimuthal segmentation 30, as shown in FIG. 3. A mirror segment 32 of this type or a mirror edge can be described by approximation by a sectional surface of a cylinder. This greatly facilitates the production of the mirror shell segments. However, this approximation also leads to the diameter of the light spot in the focal plane being larger.

The cylinder approximation lies in adapting a cylinder surface to the conical surface that represents the paraboloid section. This is very successful, as long as the azimuthal segment size 30 is small compared to the radius of the shells 34, i.e., b_{segment}<<Rₛₕₑₗₗ applies. The consequence of this approximation is that the light spot becomes larger in the focal plane.

3. Cylinder Approximation with Rotated Cylinder Surfaces

The subject matter of an exemplary embodiment of the invention is a modification of the cylinder approximation, which makes it possible to substantially reduce the size of the light spot diameter with respect to the cylinder approximation. It is thus possible to achieve a light spot of the size of the conical approximation to the Wolter-I optics with cylinder shell sections. In this manner the advantages of the easier production of cylinder shell segments have been effected without any significant loss of the resolution capability of the telescope.

According to an exemplary embodiment, the modification lies in the cylinder segments 40 being rotated around the radial axis 42 of the mirror shell arrangement of the telescope, which runs through the center of the mirror shell segment. An arrangement of this type of the rotation of the cylinder segments around the radial axis of the telescope arrangement is shown in FIG. 4. The exemplary embodiment shows that the diameter of the light spot in the focal plane can thus be reduced by a factor of three. The improvement is dependent on the distance of the mirror segment from the symmetry axis: it increases, the smaller the distance. Since the exemplary embodiment relates to a tandem mirror of the periphery of the telescope, much smaller light spot diameters are achieved for the inner tandem mirror.

FIGS. 5A and 5B show an exemplary embodiment of the mirror element according to the invention in different sectional representations. FIG. 5A hereby shows a cross-sectional representation of the exemplary embodiment of the mirror element according to the invention. The mirror element thereby comprises a first mirror edge 52 and a second mirror edge 54, both of which are adjacent to one another. The first mirror edge 52 is hereby arranged at a radial spacing 56 around a first edge axis 58. The first mirror edge 52 is formed from a cylinder segment or a cylinder surface section. The first edge axis 58 is thereby tilted with respect to the focal axis 25. Furthermore, the second mirror edge 54 also comprises a cylinder surface section, which is arranged in a second at a radial spacing 60 around a second edge axis 62. The second edge axis 62 is thereby tilted with respect to the first edge axis 58 so that the play element comprising the first in mirror edge 52 and the second mirror edge 54 has a bent form. It can be ensured through this that x-rays that strike the mirror element at a direction of incidence parallel to the focal axis 25 are focused on a focal point not shown in FIG. 5A.

FIG. 5B show a top plan representation of the mirror element shown in FIG. 5A, at the same time mirror elements arranged adjacently likewise being shown. FIG. 5B likewise shows the focal axis 25 as well as the first edge axis 58 and the second edge axis 62. The first and second mirror edge 52 or 54 of the individual mirror elements are thereby again cylinder surface sections, as has already been described in connection with FIG. 5A. Furthermore, FIG. 5B shows that according to the invention a rotation is turned around a radial axis (not shown here) arranged at right angles to the focal axis 25, so that an offset angle 64 is formed between the focal axis 25 under the first or second edge axis 58 or 62. The improvement in the optical resolution, which is the object according to the invention, can now be achieved through this offset angle 64.

Furthermore, adjacent mirror elements, such as those shown by reference numbers 66 and 68 in FIG. 5B, can also be arranged in a stepped offset 70 so that the structure shown in FIG. 5B results. It can be ensured hereby that a limit between the first mirror edge 52 and the second mirror edge 54 lies as far as possible in a narrow lateral range so that a focusing of light rays or x-rays from different mirror elements are all focused as far as possible on a small focal point. Also through the structure shown in FIG. 5B a ring shape can be formed around in the focal axis 25, as shown, e.g., in FIG. 2. A shape of this type is already indicated to some extent in FIG. 4.

According to the invention, the improvement in the focusing of an x-ray is achieved in that a better approximation of the Wolter-I optics can be achieved through the offset angle 64 than if the boundary line between one of the first mirror edge 52 and the second mirror edge 54 is horizontal, that is, at right angles to the focal axis 25.

A concrete exemplary embodiment of the present invention compared to a conical as well as a simple cylinder approximation is described in more detail below.

A model of the conical approximation of the Wolter-I optics and the unmodified and modified cylinder approximation (i.e., of an exemplary embodiment of the present invention) of the conical approximation of the Wolter-I optics was produced with the aid of the “ASAP” optics program. With the aid of geometrical-optical ray-tracing calculations, the light spot was calculated in the focal plane of the arrangement (spot diagram).

### —Geometry Parameters

Distance between mirror shells and focal plane f=50000 mm
Radius of the mirror shell boundary: R=3500 mm

### —Conical Approximation of the Wolter-I Optics

### Light Source

Light rays 24 (especially x-rays) fall parallel to the symmetry axis 25 of the telescope on the annular arrangement of a tandem mirror 40, which is composed of the mirror shell that represents the conical approximation of the paraboloid and the second mirror shell that represents the conical approximation of the hyperboloid. The grid of the light rays is indicated in FIG. 6, the left part of the image showing a top plan representation and the right part of the image showing a front view representation of a telescope of this type. Light spot in the focal plane:

A rotationally symmetrical light spot then results in the center of the focal plane, the diameter of which light spot is approx. 0.6 mm. This is shown by the dimensions of the diagram shown in FIG. 7, which represents the impact points of the rays in the focal plane. As can be expected, the symmetry is maintained and the image points of the individual rays lie on circles. The consequence of a shift of the focal plane along the telescope axis is that the light spot becomes larger, irrespective of the shift direction. This shows that in fact the focal plane is present. FIG. 7 thereby shows a spot diagram in the focal plane. The two conical mirror shells are illuminated with axial light rays. The spot diameter is 0.42 mm.

### —Cylinder Approximation

An azimuthal segment corresponds, for example, to a 360^{th} of an arc, that is, one degree; With a circular radius of 3500 mm, that means an arc length of b=(2π/360) 1 deg 3500 mm=61 mm. One cylinder surface respectively has been adapted to the conical surfaces 1 and 2, which correspond to the mirror surfaces 52 and 54. This is very possible, because the arc length is very much smaller than the circular radius. FIG. 8 shows an image of a tandem of this type of two cylinder surfaces.

The deviation of the cylinder surfaces from the conical surfaces is always less than one micrometer. FIGS. 9A and 9B show that the difference in the case of the mirror surface 1 (corresponding to the mirror edge 52, therefore labeled by reference number 52′) is less than 10 nm (FIG. 9A), in the case of the mirror surface 2 (corresponding to mirror edge 54, therefore labeled by reference number 54′) it is less than 200 nm (FIG. 9B). Thus in FIG. 9A the deviation from the conical approximation is shown as the difference between the cylinder approximation of the conical surface that describes the paraboloid of the Wolter-I optics, while in FIG. 9B the deviation from the conical approximation is shown as the difference between the cylinder approximation of the conical surface that describes the hyperboloids of the Wolter-I optics. The y-axis gives the deviation in micrometers.

### Light Source:

The tandem of cylinder mirrors 52′, 54′ is illuminated with light rays 24. The light rays 24 run parallel to the telescope axis 25, their spatial arrangement is shown in FIG. 10, in which the illumination of the tandem is shown from two cylinder shells 52′ and 54′. The arc section is shown in an exaggerated manner; the azimuth angle is in fact approx. 1 degree.

### Light Spot in the Focal Plane:

A cylinder tandem mirror generates a light spot in the center of the focal plane, which light spot is unsymmetrical. Its maximum extension lies in the direction perpendicular to the tandem mirror and is approx. 0.82 mm, as can be seen from the spot diagram from FIG. 11. An arrangement of several cylinder tandem mirrors such that a complete ring of mirror shells is produced, then results in a round light spot in the center of the focal plane, the diameter of which light spot is approx. 0.82 mm. FIG. 11 thereby shows a spot diagram in the focal plane which generates a tandem from two described cylinder surfaces from the axially incident light rays. The spot diameter is 0.82 mm.

—Cylinder Approximation with Rotated Cylinder Surfaces (Arrangement According to an Exemplary Embodiment of the Present Invention).

The surfaces of the modified (i.e., rotated according to the invention) and unmodified cylinder approximation of the mirror surface 52 or 52′ differ by less than 40 micrometers; the surfaces of the modified and unmodified cylinder approximation of the mirror surface 54 and 54′ differ by less than 60 micrometers. Although these are small numbers compared to the lateral dimensions of the mirror surfaces, they still represent significant deviations, if one considers that the difference between cylinder and conical approximation is smaller by three orders of magnitude. FIG. 12A shows the deviation of the modified (rotated) and unmodified cylinder approximation for the mirror surface 52 or 52′, while FIG. 12B shows the deviation of the modified (rotated) and unmodified cylinder approximation for the mirror surface 2 of the tandem mirror.

### Light Source:

In order to have a direct comparison, the same light source has been used as in the previous section.

### Light Spot in the Focal Plane:

The diameter of the light spot can be substantially reduced by rotating the tandem of the two cylinder mirrors 52 and 54 around the radial axis of the telescope arrangement by 1,00713 degrees. As shown in FIG. 13, the maximum extension of the light spot is approx. 0.25 mm. An arrangement of several cylinder tandem mirrors such that a complete ring of mirror shells is produced, then results in a round light spot in the center of the focal plane, the diameter of which light spot is approx. 0.25 mm. That is smaller by approx. a factor of 3.3 than in the case of the unmodified cylinder approximation and smaller by approx. a factor of 2.4 than in the case of the conical approximation of the Wolter-I optics.

FIG. 13 thereby shows a spot diagram in the focal plane that generates a tandem of two rotated cylinder surfaces from the axially incident light rays. The spot diameter is 0.25 mm.

Reference Numbers

| | |
|---|---|
| 10 | Base |
| 12 | Cylindrical mirror shells |
| 14 | Webs |
| 20, 22 | Mirror shells |
| 23 | Focal plane |
| 24 | Light rays, x-rays |
| 24a | Spacing between the focal plane and |
| | the mirror shells |
| 25 | Focal axis, telescope axis |
| 26 | Radius of the mirror shells |
| 27 | Light spot |
| 30 | Azimuthal segmentation |
| 32 | Mirror segment |
| 34 | Radius of the shells of the cylinder approximation |
| 40 | Cylinder segment |
| 42 | Radial axis |
| 52 | First mirror edge |
| 54 | Second mirror edge |
| 56 | Radial spacing from the first mirror |
| | edge to the first edge axis 58 |
| 58 | First edge axis |
| 60 | Radial spacing from the second mirror |
| | edge to the second edge axis 62 |
| 62 | Second edge axis |
| 64 | Offset angle |
| 66, 68 | Further mirror elements |
| 70 | Stepped offset |

1. Device for improving the resolution capability of an x-ray optical apparatus for an x-ray (24) incident from a direction of incidence, comprising
a mirror element (52, 54) with a mirror edge (52), the mirror edge (52) being formed around an edge axis (58) by a cylindrical shell section, and the mirror element (52, 54) being arranged spaced apart in a radial direction (42) with respect to a focal axis (25) parallel to the direction of incidence by a focal point of the x-ray optical apparatus, and the mirror element (52, 54) being furthermore arranged rotated about an axis extending in the radial direction (42) with respect to the direction of incidence such that the edge axis (58) is tilted with respect to the direction of incidence.

2. Device according to claim 1, characterized in that a second mirror edge (54) is provided adjacent to the mirror edge (52), which second mirror edge is formed about a second edge axis (62) by a second cylindrical shell section, where the mirror element (52, 54) is arranged such that a plane comprising the edge axis (58) and second edge axis (62) is tilted with respect to the direction of incidence.

3. Device according to claim 2, characterized in that the mirror edge (52) corresponds to an approximation of a hyperbolic form and the second mirror edge (54) to an approximation of a parabolic form.

4. Device according to claim 1, characterized in that the mirror element (52, 54) has a width that is smaller than approximately a tenth of the radial distance of the mirror element regarding the focal axis (25).

5. Device according to claim 4, characterized in that the mirror element (52, 54) has a width that corresponds to an arc length of less than approximately two degrees in the radial direction (42).

6. Device according to claim 1, characterized in that a tilt between the edge axis (58) and the direction of incidence lies in a range between approx. half a degree and approx. 5 degrees.

7. Device according to claim 1, characterized in that the device has another mirror element (66, 68) with a third mirror edge (52) and a fourth mirror edge (54) adjacent to the third mirror edge (52), the third mirror edge (52) being formed around a third edge axis by a third cylindrical shell section and the other mirror element (66, 68) being arranged spaced apart with respect to the focal axis in another radial direction, and the other mirror element (66, 68) furthermore being arranged rotated about another axis extending in the other radial direction with respect to the direction of incidence, such that the third edge axis is tilted with respect to the direction of incidence.

8. Device according to claim 7, characterized in that the other mirror element (66, 68) is adjacent to the mirror element (52, 54) and is arranged at a distance from the focal axis (25) that corresponds to the distance of the mirror element (52, 54) from the focal axis (25), a transition between the mirror element (52, 54) and the other mirror element (66, 68) having a stepped offset (70).

9. Device according to claim 7, characterized in that the device comprises a plurality of additional mirror element (66, 68) that form a ring of mirror elements around the focal axis.

10. Device according to claim 1, characterized in that the device has an additional mirror element that is arranged spaced apart from the focal axis in the radial direction, a spacing of the additional mirror element from the focal axis (25) being larger than the spacing of the mirror element (52, 54) from the focal axis (25).
